(19) United States
(12) Patent Application Publication
(10) Pub. No.: US 2022/0039590 A1
(43) Pub. Date: Feb. 10, 2022

(54) COVER OF A KNOCKBOX BAR FOR ESPRESSO COFFEE MACHINES

(71) Applicant: BREMAL S.R.L., Lurate Caccivio (CO) (IT)

(72) Inventor: Francesco BREVI, Lurate Caccivio (CO) (IT)

(21) Appl. No.: 17/339,235

(22) Filed: Jun. 4, 2021

(30) Foreign Application Priority Data
Aug. 4, 2020 (IT) 102020000019168

(51) Int. Cl. A47J 31/60

(52) U.S. Cl. CPC A47J 31/60; F16L 11/12

(57) ABSTRACT

Disclosed is a substantially tubular device reversibly applicable to a knockbox bar for espresso coffee machines to cover the bar. The device is elastically deformable and is applicable to a knockbox bar by spreading a slot extending longitudinally into the device over the entire length thereof. The device protects the knockbox bar on which it is applied from both the impact against the filter holder assembly and the coffee powder ejected therefrom. The device includes, close to a first end, flaps arranged longitudinally allowing easy cleaning of the filter edge from any powder possibly compacted therein. The device further includes, close to a second end opposite the first, grooves acting as facilitated cutting lines and by virtue of which it is possible to shorten, if required, the device so as to adapt it to the length of the knockbox bar to which it is be applied.

### FIELD OF APPLICATION OF THE INVENTION

The present invention applies to the field of espresso coffee machines.

As known, in order to make a coffee beverage (generally referred to as “coffee”) using an espresso coffee machine, a few grams of ground (not completely water-soluble) coffee are placed in a concave metal filter accommodated, in turn, in a so-called “filter holder” assembly, which can be easily grasped by an operator by means of an appropriate handle. The filter holder assembly is then connected to the so-called “dispenser” assembly from which hot water is sprayed, by means of a “shower”, onto the ground coffee at a pressure usually equal to 9 atm. The water is impregnated with coffee and, coming out of the filter holder assembly, is conveyed into one or two cups according to the number of “spouts” with which the filter holder assembly is provided.

Espresso coffee machines generally rest on a worktop, under which there is a container for collecting the “exhausted” coffee, i.e. the coffee which has already been used to prepare a beverage. The coffee, as well as the filter holder assembly, when crossed by water, heat up to the point of becoming scalding. In order to remove coffee from the filter after a beverage has been dispensed, the operators usually uncouple the filter holder assembly from the dispenser assembly, turn the filter holder assembly upside down and knock it (from the top downwards) against a bar appropriately arranged inside the aforementioned container (usually referred to as a “knockbox”) at or close to the opening thereof. When the filter holder assembly is knocked against the aforesaid bar (also referred to as a “knockbox bar”), the ground coffee is ejected from the filter by inertia, projected into the container. Doing so, the exhausted coffee can be removed from the filter without coming into contact in any manner with the coffee or the filter holder assembly, so as to avoid the risk of scalding.

The present invention relates to an accessory which is reversibly connectable to a knockbox bar for espresso coffee machines.

Incidentally, asserting that an accessory is reversibly connectable to a knockbox bar means that said accessory is connectable to said bar and disconnectable therefrom for an indefinite number of times.

### OVERVIEW OF THE PRIOR ART

The knockbox containers usually appear as sliding or tilting drawers accommodated in seats generally obtained, for convenience, in the cabinet on which the espresso coffee machine rests, preferably immediately below the cup holder surface of the machine itself.

As mentioned above, in order to eject the exhausted coffee from the filter of a filter holder assembly and project it into a knockbox container, the filter holder assembly is knocked against the knockbox bar of said container. Therefore, the knockbox bar gradually tends to wear out until it needs to be replaced. This is a disadvantage since the knockbox bar is usually not removable from the container where it is housed. Therefore, in order to replace said bar, an operator is forced to remove the knockbox container from the seat thereof.

In addition to the above, when a filter holder assembly is knocked against a knockbox bar, the coffee, in addition to being projected into the container, deposits on the knockbox bar, progressively accumulating with the dispensing of coffee beverages. The more coffee deposited on the knockbox bar, the greater the risk that, with each impact of a filter holder assembly against the bar, small amounts of exhausted coffee will come out of the knockbox container. To avoid this possibility, the knockbox bar needs to be periodically cleaned in order to remove the coffee deposited thereon. Unfortunately, as specified above, the knockbox bar is usually not removable from the container where it is housed. Therefore, in order to clean said bar adequately, an operator is forced to remove the knockbox container from the seat thereof. Since the frequency with which a knockbox container needs to be emptied is significantly lower than that with which the knockbox bar housed therein needs to be cleaned, the fact that the knockbox bar highly gets dirty forces an operator of an espresso coffee machine to stop dispensing coffee beverages and clean the knockbox bar together with the container which includes it, even when the latter is not full.

### OBJECTS OF THE INVENTION

It is the object of the present invention to overcome the aforementioned drawbacks by suggesting a device adapted both to protect a knockbox bar for espresso coffee machines from the impact of a filter holder assembly against said bar, and to prevent the latter from getting dirty with exhausted coffee whenever a filter holder assembly is knocked against it.

### SUMMARY AND ADVANTAGES OF THE INVENTION

The present invention relates to a device which is reversibly connectable to a knockbox bar for espresso coffee machines so as to cover said bar at least partially,

said device being elongated in shape so as to comprise a first end and a second end opposite to said first end,

said device extending from said first end to said second end in a direction referred to as “longitudinal” later in the present description,

said device further comprising:
a wall extending in said longitudinal direction,
said wall being at least partially concave so as to delimit, at least partially, a cavity also extending in said longitudinal direction,
said wall being partially delimited by a first and a second edge which are mutually opposite to each other and each of which extending in said longitudinal direction,
said wall, at least at said cavity, being elastically deformable so as to reduce the curvature of said wall (i.e. so as to reduce the deviation of said wall from a flat development),
said cavity acting as a seat where a knockbox bar for espresso coffee machines is housable, at least partially, following an elastic deformation of said wall, at least at said cavity, which has reduced the curvature thereof,

when a knockbox bar for espresso coffee machines is housed, at least partially, in said cavity, said knockbox bar being:
at least partially covered by said wall,
reversibly connected to said wall due to an elastic return of the latter (so that said device is connected to said knockbox bar)
and
   de-housable from said cavity (so as to disconnect said device from said knockbox bar) by elastically deforming said wall, at least at said cavity, so as to reduce the curvature of said wall;
at least one relief protruding, from a first portion of said wall, from the opposite side with respect to said cavity,
said relief being elongated in shape and extending, at least partially, in a direction which is not orthogonal to said longitudinal direction.

The device of the invention is easily and reversibly connectable to a knockbox bar so as to cover the latter at least partially. When the aforesaid device is connected to a knockbox bar, it advantageously protects said bar from the impact of a filter holder assembly against it. In addition to this, the coffee projecting from the filter when the filter holder assembly impacts against said bar, instead of partially depositing on the latter, accumulates on the wall of the device. In order to remove the coffee accumulated on the device of the invention (instead of precipitated in the container) it is simply necessary to remove the device from said bar and wash it. These operations are much easier than removing the knockbox container from the seat thereof and washing the bar together with the container.

The device of the invention, by virtue of the presence of the aforesaid relief, allows overcoming a further disadvantage.

As previously mentioned, in order to make a coffee beverage using an espresso coffee machine, a few grams of ground coffee are placed in a concave metal filter which is in turn housed in a filter holder assembly. Since this operation is to be carried out quickly by a person assigned to the machine, it often occurs that coffee powder undesirably deposits on the filter edge rather than therein. When the filter holder assembly is connected to the dispenser assembly, said coffee powder deposited on the filter edge is pressed against said edge, adhering to the latter. When a beverage is dispensed, the heat which is transferred by the water to the filter holder assembly makes the aforesaid coffee powder further adhere to the filter edge. When removing the exhausted coffee from the filter, the adhesion of the coffee powder to the filter edge is such as not to detach said powder when the filter holder assembly impacts against the knockbox bar. This is a problem since if said compacted and heated coffee powder falls into the filter, it compromises the taste of the coffee beverage which is then dispensed. Each time the filter holder assembly is used, the operator of the espresso coffee machine is thus forced to clean the filter edge after having projected the exhausted coffee into the knockbox container. This cleansing operation is usually performed by cleaning the filter edge with a traditional cloth or sponge. However, the latter do not always allow the edge to be cleansed optimally.

Advantageously, by applying the device of the invention to a knockbox bar, the operator of the espresso coffee machine can easily and effectively clean the filter edge from the coffee powder compacted therein by placing and pressing said edge against the aforesaid relief while the filter holder assembly is still overturned (after the latter has been knocked against the bar), and moving the filter holder assembly transversely to the bar in mutually opposite directions (i.e., “back and forth”), so as to make the filter edge rub against said relief. The friction between the latter and the coffee powder adhering to the filter edge causes said powder to detach from the filter holder assembly, thus clearing the aforesaid edge.

The device of the invention is preferably made of silicone and/or polyurethane rubber and/or polyvinyl chloride and/or a similar material. By virtue of this, said device, in addition to being dishwasher safe, is softer than the knockbox bars to which it is connectable. Therefore, there is less risk that an operator of an espresso coffee machine could injure his/her wrist when repeatedly knocking a filter holder assembly against a knockbox bar. The softness of the device of the invention further advantageously attenuates the noise caused by the impact of a filter holder assembly against a knockbox bar.

Incidentally and for the avoidance of doubt, two adjacent grooves extending into the wall of the device of the invention so as to delimit a ridge (interposed therebetween) are equivalent to the aforementioned relief projecting from said wall.

Other innovative features of the present invention are disclosed in the description below and referred to in the dependent claims.

According to an aspect of the invention, said wall, at least at said cavity, is in the shape of a cylindrical wall portion, the generatrixes of which extend in said longitudinal direction.

Advantageously, since the knockbox bars are substantially cylindrical, the device according to this aspect of the invention tends to adhere to the knockbox bar to which it is applied.

According to another aspect of the invention, said cylindrical wall portion, and said cavity and said first and second edges therewith, extend from said first end to said second end.

According to another aspect of the invention, said first and second edges are opposite to each other so that said wall, at least at said cavity, is substantially in the shape of a hollow cylindrical element (i.e. of a tubular element) extending from said first end to said second end and comprising a through slot also extending in said longitudinal direction from said first end to said second end,

said first and second edges corresponding to two lips of said slot, respectively, so that a knockbox bar is housable, at least partially, inside said hollow cylindrical element or de-housable from the latter by elastically spreading said slot.

Incidentally, in the device according to this aspect of the invention, the aforesaid cavity acting as a seat for at least partially housing a knockbox bar corresponds to the cavity of said tubular element.

Advantageously, according to this aspect of the invention, since the knockbox bars are substantially cylindrical and the wall of the device substantially tubular, the device of the invention, when applied to a knockbox bar, almost entirely covers said bar.

According to another aspect of the invention, said first wall portion is closer to one end of said first and second ends than to the other of said ends.

According to this aspect of the invention, the relief is in an off-center position.

By virtue of this, it is advantageously more unlikely that said relief will be undesirably hit (and thus damaged) by the filter holder assembly when the latter is knocked against the knockbox bar.

According to another aspect of the invention, the device comprises a plurality of said reliefs projecting from said first wall portion.

According to another aspect of the invention, said reliefs are placed side by side so that said first wall portion is “in relief”.

Advantageously, according to this aspect of the invention, when the device is connected to a knockbox bar, regardless of how it is oriented, it is more likely than if the device includes a single relief, that one or more reliefs face upwards (and therefore in an optimal position for rubbing the filter edge of a filter holder assembly against them).

According to another aspect of the invention, said first wall portion extends from said first edge to said second edge.

Advantageously, according to this aspect of the invention, since the first portion of the device wall extends from one of the aforesaid edges to the other, it is even more likely that, when the device is connected to a knockbox bar, one or more reliefs face upwards.

According to another aspect of the invention, said relief, or said reliefs if more than one, extends/extend in said longitudinal direction.

Advantageously, according to this aspect of the invention, when the device is connected to a knockbox bar, the reliefs are oriented parallel to said bar (since the aforesaid longitudinal direction also is the direction in which said device extends), i.e. optimally for the purpose of removing the coffee powder adhering to the filter edge of a filter holder assembly by rubbing.

According to another aspect of the invention, the device comprises one or more non-through grooves obtained in said wall at a second portion of the latter, on the opposite side with respect to said cavity,

said second wall portion is closer to one end of said first and second ends than to the other of said ends,

said grooves being placed side by side and each of them extending from said first edge to said second edge.

The aforesaid grooves act as facilitated cutting lines and are suitable for allowing an easy removal of an end wall section (and therefore of the device) by an operator of an espresso coffee machine. Advantageously, according to this aspect of the invention, if the device is too long with respect to the knockbox bar to which it is to be applied, it is possible to reduce the length thereof (i.e., the extension thereof in the longitudinal direction) to adapt it to that of said bar.

### BRIEF DESCRIPTION OF THE DRAWINGS

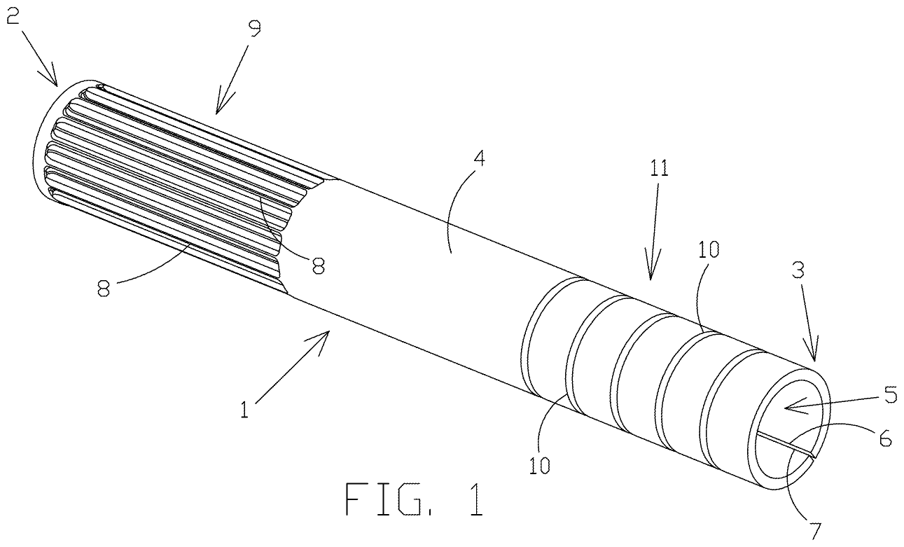

Further objects and advantages of the present invention will become apparent from the following detailed description of embodiments thereof and from the accompanying drawing (FIG. 1), given by way of mere non-limiting example, which shows a perspective view of a device of the invention. The scale and proportions of the various depicted elements do not necessarily correspond to the real ones.

### DETAILED DESCRIPTION OF SOME PREFERRED EMBODIMENTS OF THE INVENTION

FIG. 1 shows a device 1 of the invention, which is reversibly connectable to a knockbox bar for espresso coffee machines so as to cover said bar at least partially. The device 1 is elongated in shape so as to comprise a first end 2 and a second end 3 opposite to the end 2. More precisely, the device 1 comprises a wall 4 preferably extending from the end 2 to the end 3 in the longitudinal direction. The wall 4 is at least partially concave, so as to delimit, at least partially, a cavity 5 also extending in the longitudinal direction, preferably from the end 2 to the end 3. The wall 4 is partially delimited by a first edge 6 and a second edge 7 which are mutually opposite to each other and each of which extending in the longitudinal direction, preferably from the end 2 to the end 3. As can be seen in the figure, the wall 4 is preferably in the shape of a cylindrical wall portion, the generatrixes of which extend in a longitudinal direction. More preferably, the edges 6 and 7 are opposite to each other so that the wall 4 is substantially in the shape of a hollow cylindrical element (i.e. of a tubular element) extending from the end 2 to the end 3 and comprising a through slot also extending in the longitudinal direction from the end 2 to the end 3. The edges 6 and 7 correspond to the two lips of the aforesaid slot.

Incidentally, like the wall 4, the device 1 extends in the longitudinal direction from the end 2 to the end 3.

The wall 4 is elastically deformable (at least at the cavity 5) so as to reduce the curvature of said wall 4 (i.e. so as to reduce the deviation of the wall 4 from a flat development). For this purpose, the wall 4 is preferably made of silicone and/or polyurethane rubber and/or polyvinyl chloride and/or a similar material.

The cavity 5 acts as a seat where a knockbox bar for espresso coffee machines is housable, at least partially, by elastically deforming the wall 4 so as to reduce the curvature thereof. When a knockbox bar is at least partially housed in the cavity 5, said bar is at least partially covered by the wall 4 and reversibly connected to the latter (i.e. to the device 1) due to the elastic return of said wall 4. In order to de-house a knockbox bar from the cavity 5 (and therefore disconnect the device 1 from said bar), it is simply necessary to deform the wall 4 elastically again so as to reduce the curvature thereof. Since the knockbox bars are substantially cylindrical and the wall 4 is preferably in the shape of a hollow cylindrical element, the device 1 tends to adhere to the knockbox bar to which it is applied, covering it almost entirely. In addition to this, since the edges 6 and 7 are preferably opposite to each other so as to correspond to the two lips of the aforementioned through slot which extends into the wall 4, in order to house a knockbox bar in the cavity 5, or to de-house said bar from said cavity 5, it is necessary to elastically spread the aforesaid slot.

The device 1 comprises one or more reliefs 8 projecting from a portion 9 of the wall 4, on the opposite side with respect to the cavity 5 (i.e. outwards, from the outer surface of the wall 4). The reliefs 8 are elongated in shape, so as to appear as “flaps”, and extend, at least partially, in a direction which is not orthogonal to the longitudinal direction in which the wall 4 extends (and the device 1 therewith). Preferably, the device 1 comprises a plurality of reliefs 8 placed side by side so that the portion 9 of the wall 4 appears “in relief”. More preferably, the reliefs 8 are mutually parallel and extend in the longitudinal direction. The portion 9 preferably extends from the edge 6 to the edge 7. The reliefs 8 are preferably present on an entire cylindrical section of the wall 4. The portion 9 is preferably off-center. More precisely, the portion 9 is closer to the end 2 than to the end 3.

As can be seen in the FIGURE, the reliefs 8 are obtainable by creating a plurality of adjacent grooves on the outer surface of the wall 4. In fact, two adjacent grooves extending into the wall 4 so as to delimit a ridge are equivalent to a relief projecting from said wall 4.

The device 1 preferably comprises one or more non-through grooves 10 obtained in the wall 4 in a second portion 11 of the latter, on the opposite side with respect to the cavity 5 (i.e. outwards, from the outer surface of the wall 4). The grooves 10 are placed side by side and are preferably arranged orthogonally to the longitudinal direction in which the device 1 extends. Each groove 10 preferably extends from the edge 6 to the edge 7. Since the wall 4 is preferably substantially in the shape of a hollow cylindrical element and the grooves 10 are preferably arranged orthogonally to the longitudinal direction in which the device 1 extends, each groove 10 is preferably in the shape of an arc of circumference. The portion 11 is preferably off-center. More precisely, the portion 11 is closer to the end 3 than to the end 2.

The device 1 has a length preferably between 310 mm and 330 mm, and more preferably equal to 320 mm. The device 1 has an inner diameter preferably between 30 mm and 45 mm, and more preferably between 35 mm and 40 mm. The distance (measured in the longitudinal direction) between the end 2 and the groove 10 closest to the latter is preferably between 210 mm and 230 mm, and is more preferably equal to 220 mm.

Based on the description given for a preferred embodiment, it is obvious that changes may be introduced by those skilled in the art without departing from the scope of the invention as defined by the following claims.

1. A device which is reversibly connectable to a knockbox bar for espresso coffee machines so as to cover said bar at least partially,
said device being elongated in shape so as to comprise a first end and a second end opposite to said first end,
said device extending from said first end to said second end in the longitudinal direction,
said device comprising:
a wall extending in said longitudinal direction,
said wall being at least partially concave so as to delimit, at least partially, a cavity also extending in said longitudinal direction,
said wall being partially delimited by a first and a second edge mutually opposite to each other and each of which extending in said longitudinal direction,
said wall, at least at said cavity, being elastically deformable so as to reduce the curvature of said wall,
said cavity acting as a seat where a knockbox bar for espresso coffee machines is housable, at least partially, following an elastic deformation of said wall, at least at said cavity, which has reduced the curvature thereof,
when a knockbox bar for espresso coffee machines is housed, at least partially, in said cavity, said knockbox bar being:
at least partially covered by said wall,
reversibly connected to said wall due to an elastic return of the wall and
de-housable from said cavity by elastically deforming said wall, at least at said cavity, so as to reduce the curvature of said wall;
a plurality of reliefs each of which protruding, from a first portion of said wall, from the opposite side with respect to said cavity,
each of said reliefs being elongated in shape and extending, at least partially, in a direction which is not orthogonal to said longitudinal direction,
wherein said first portion of said wall is closer to said first end than to said second end,
a further portion of said wall, consecutive to said first portion and further away from said first end than said first portion, being devoid of said reliefs.

2. The device according to claim 1, wherein said wall, at least at said cavity, is in the shape of a cylindrical wall portion, the generatrixes of which extend in said longitudinal direction.

3. The device according to claim 2, wherein said cylindrical wall portion, and said cavity and said first and second edges therewith, extend from said first end to said second end.

4. The device according to claim 3, wherein said first and second edges are opposite to each other so that said wall, at least at said cavity, is substantially in the shape of a hollow cylindrical element extending from said first end to said second end and comprising a through slot also extending in said longitudinal direction from said first end to said second end,
said first and second edges corresponding to two lips of said slot, respectively, so that a knockbox bar is housable, at least partially, inside said hollow cylindrical element or de-housable from the hollow cylindrical element by elastically spreading said slot.

5. The device according to claim 1, wherein said reliefs are placed side by side.

6. The device according to claim 5, wherein said first portion of said wall extends from said first edge to said second edge.

7. The device according to claim 1, wherein each of said reliefs extends in said longitudinal direction.

8. The device according to claim 1, further comprising one or more non-through grooves obtained in said wall at a second portion of the wall, on the opposite side with respect to said cavity,
said second portion of said wall being closer to said second end than to said first end,
said further portion of said wall being interposed between said first and second portions of said wall,
said grooves being placed side by side and each of them extending from said first edge to said second edge.

9. The device according to claim 2, wherein each of said reliefs extends in said longitudinal direction.

10. The device according to claim 3, wherein each of said reliefs extends in said longitudinal direction.

11. The device according to claim 4, wherein each of said reliefs extends in said longitudinal direction.

12. The device according to claim 5, wherein each of said reliefs extends in said longitudinal direction.

13. The device according to claim 6, wherein each of said reliefs extends in said longitudinal direction.

14. The device according to claim 2, further comprising one or more non-through grooves obtained in said wall at a second portion of the wall, on the opposite side with respect to said cavity,
said second portion of said wall being closer to said second end than to said first end,
said further portion of said wall being interposed between said first and second portions of said wall,
said grooves being placed side by side and each of them extending from said first edge to said second edge.

15. The device according to claim 3, further comprising one or more non-through grooves obtained in said wall at a second portion of the wall, on the opposite side with respect to said cavity,
said second portion of said wall being closer to said second end than to said first end,
said further portion of said wall being interposed between said first and second portions of said wall,
said grooves being placed side by side and each of them extending from said first edge to said second edge.

16. The device according to claim 4, further comprising one or more non-through grooves obtained in said wall at a second portion of the wall, on the opposite side with respect to said cavity,
said second portion of said wall being closer to said second end than to said first end,
said further portion of said wall being interposed between said first and second portions of said wall,
said grooves being placed side by side and each of them extending from said first edge to said second edge.

17. The device according to claim 5, further comprising one or more non-through grooves obtained in said wall at a second portion of the wall, on the opposite side with respect to said cavity,
said second portion of said wall being closer to said second end than to said first end,
said further portion of said wall being interposed between said first and second portions of said wall,
said grooves being placed side by side and each of them extending from said first edge to said second edge.

18. The device according to claim 6, further comprising one or more non-through grooves obtained in said wall at a second portion of the wall, on the opposite side with respect to said cavity,
said second portion of said wall being closer to said second end than to said first end,
said further portion of said wall being interposed between said first and second portions of said wall,
said grooves being placed side by side and each of them extending from said first edge to said second edge.

19. The device according to claim 7, further comprising one or more non-through grooves obtained in said wall at a second portion of the wall, on the opposite side with respect to said cavity,
said second portion of said wall being closer to said second end than to said first end,
said further portion of said wall being interposed between said first and second portions of said wall,
said grooves being placed side by side and each of them extending from said first edge to said second edge.

20. The device according to claim 9, further comprising one or more non-through grooves obtained in said wall at a second portion of the wall, on the opposite side with respect to said cavity,
said second portion of said wall being closer to said second end than to said first end,
said further portion of said wall being interposed between said first and second portions of said wall,
said grooves being placed side by side and each of them extending from said first edge to said second edge.
